(19) United States
(12) Patent Application Publication
(10) Pub. No.: US 2019/0324304 A1
(43) Pub. Date: Oct. 24, 2019

(54) PHOTOGRAPHIC CAMERA AND DISPLAY DEVICE

(71) Applicants: Beijing BOE Optoelectronics Technology Co., Ltd., Beijing (CN); BOE Technology Group Co., Ltd., Beijing (CN)

(72) Inventors: Lei CHEN, Beijing (CN); Xuerong WANG, Beijing (CN); Jingzhe FANG, Beijing (CN); Yang ZHAO, Beijing (CN); Lingyun SHI, Beijing (CN); Haiwei SUN, Beijing (CN); Qi ZHANG, Beijing (CN)

(21) Appl. No.: 16/074,827

(22) PCT Filed: Jan. 15, 2018
(86) PCT No.: PCT/CN2018/072557

§ 371 Date: Aug. 2, 2018

(30) Foreign Application Priority Data
May 12, 2017 (CN) 201720538661.9

(51) Int. Cl. G02F 1/1334; G02F 1/1343; G02F 1/155; H04N 5/225

(52) U.S. Cl. CPC G02F 1/1334; H04N 5/225; G02F 1/155; G02F 1/1343

(57) ABSTRACT

The present disclosure relates to the field of display technology, and provides a photographic camera and a display device. The photographic camera includes a photographic unit and a light control structure disposed at a light entrance side of the photographic unit. Specifically, the light control structure includes a first electrode layer and a second electrode layer disposed opposite to each other, as well as an adjustment layer disposed between the first electrode layer and the second electrode layer. The first electrode layer and the second electrode layer are configured to form an electric field for controlling the light transmittance of the adjustment layer when a voltage is applied thereto.

### RELATED APPLICATION(S)

The present application claims the benefit of Chinese Patent Application No. 201720538661.9 filed on May 12, 2017, the entire disclosure of which is incorporated herein by reference.

### TECHNICAL FIELD

The present disclosure relates to the field of display technology, in particular to a photographic camera and a display device.

### BACKGROUND

With the development of information era and the popularity of mobile office, mobile video conferences, video teleconference, and the like can be done by means of electronic products equipped with cameras, such as mobile phones and notebook computers, without being limited to specific places. However, in this case, cameras in the above-mentioned electronic products are often maliciously intruded and controlled by criminals, thereby obtaining user's privacy or personal information without user's knowledge. Thus, the information security of electronic products is greatly reduced.

### SUMMARY

According to an aspect of the present disclosure, a photographic camera is provided. The photographic camera includes a photographic unit and a light control structure disposed at a light entrance side of the photographic unit. Specifically, the light control structure includes a first electrode layer and a second electrode layer disposed opposite to each other, as well as an adjustment layer disposed between the first electrode layer and the second electrode layer. Further, the first electrode layer and the second electrode layer are configured to form an electric field for controlling light transmittance of the adjustment layer when a voltage is applied thereto.

Optionally, in the photographic camera provided by an embodiment of the present disclosure, the adjustment layer includes a polymer dispersed liquid crystal layer.

Optionally, in the photographic camera provided by an embodiment of the present disclosure, a thickness of the adjustment layer is about 10 μm to 20 μm.

Optionally, in the photographic camera provided by an embodiment of the present disclosure, the adjustment layer includes a polymer stabilized liquid crystal layer, and alignment layers on both sides of the polymer stabilized liquid crystal layer.

Optionally, in the photographic camera provided by an embodiment of the present disclosure, the adjustment layer includes an electrochromic layer.

Further optionally, in the photographic camera provided by an embodiment of the present disclosure, the electrochromic layer is made of a nickel oxide electrochromic material.

Optionally, in the photographic camera provided by an embodiment of the present disclosure, the first electrode layer and the second electrode layer are both made of a transparent conductive material.

Optionally, according to an embodiment of the present disclosure, the photographic camera further includes a transparent substrate disposed on a side of the first electrode layer and/or the second electrode layer facing away from the adjustment layer.

Optionally, in the photographic camera provided by an embodiment of the present disclosure, the sum of thicknesses of the first electrode layer and the transparent substrate is about 12.5 μm to 50 μm. Alternatively, in another embodiment, the sum of thicknesses of the second electrode layer and the transparent substrate is about 12.5 μm to 50 μm.

According to another aspect of the present disclosure, a display device is provided. The display device includes the photographic camera as described in any of the above embodiments.

### BRIEF DESCRIPTION OF THE DRAWINGS

In order to illustrate technical solutions in embodiments of the present disclosure more clearly, the appended drawings needed to be used in the description of embodiments will be introduced briefly in the following. Obviously, the drawings in the following description only represent some embodiments of the present disclosure, and for those of ordinary skills in the art, other drawings can be obtained according to these drawings under the premise of not paying out creative work.

FIG. 1 shows a structural schematic diagram of a photographic camera according to an embodiment of the present disclosure;

FIG. 2 shows a structural schematic diagram of a light control structure in the photographic camera as shown in FIG. 1;

FIG. 3 shows a schematic diagram of the photographic camera as shown in FIG. 1 in an information protection state;

FIG. 4 shows another structural schematic diagram of a light control structure in the photographic camera as shown in FIG. 1;

FIG. 5 shows a schematic diagram of the photographic camera as shown in FIG. 1 in a photographing state; and

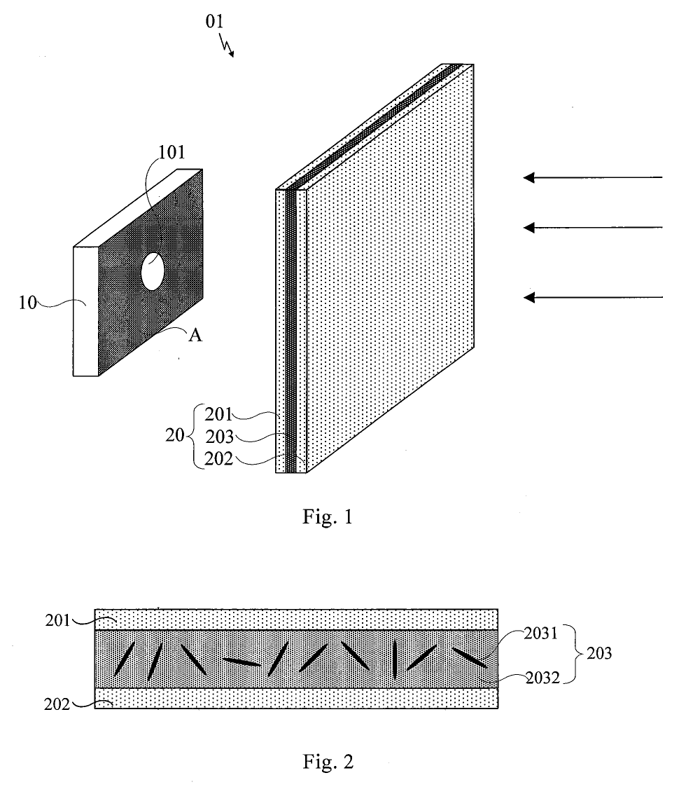

FIG. 4 shows yet another structural schematic diagram of a light control structure in the photographic camera as shown in FIG. 1.

### DETAILED DESCRIPTION OF THE EMBODIMENTS

In the following, technical solutions in embodiments of the present disclosure will be described clearly and completely in connection with the drawings in the embodiments of the present disclosure. Obviously, the described embodiments are only part of the embodiments of the present disclosure, but not all of them. Based on the embodiments in the present disclosure, all other embodiments, obtained by those of ordinary skills in the art under the premise of not paying out creative work, shall pertain to the protection scope of the present disclosure.

In order to solve problems such as information security for electronic products, software with information protection function, such as anti-virus software, is usually installed in electronic products to prevent the camera of electronic products from being illegally intruded and controlled. However, the above protective measures are generally highly dependent on the protection capabilities of software and need to be continuously updated to the latest version, so as to ensure good protection. This increases user operations and reduces the user experience of product.

The present disclosure provides a photographic camera 01. As shown in FIG. 1, the photographic camera 01 includes a photographic unit 10, wherein the photographic unit 10 mainly includes a camera lens 101 for taking a static or dynamic image. The camera lens 101 is mainly composed of a charge coupled device (CCD) image sensor or a complementary metal oxide semiconductor (CMOS) image sensor. Apparently, it should be understood that the present disclosure is not limited only to the CCD image sensor or CMOS image sensor listed above as an example. Instead, any other suitable image sensor will be readily apparent to those skilled in the art, having benefited teachings from the present disclosure.

Further, in an embodiment, the photographic camera 01 further includes a light control structure 20 disposed at the light entrance side A of the photographic unit 10.

It should be noted that, in the description of the present disclosure, the light entrance side A of the photographic unit 10 refers to a side at which the photographic unit 10 collects light from outside.

In addition, the light control structure 20 can be installed in different ways, which are not limited in this application. As an example, the light control structure 20 can be directly attached to the light entrance side A of the photographic unit 10. Alternatively, the light control structure 20 can be fixed to the light entrance side A of the photographic unit 10 by other auxiliary members, such as a mounting bracket or the like.

In view of above, the light control structure 20 includes a first electrode layer 201 and a second electrode layer 202 disposed opposite to each other, as well as an adjustment layer 203 disposed between the first electrode layer 201 and the second electrode layer 202. In this case, the first electrode layer 201 and the second electrode layer 202 are configured to form an electric field for controlling the light transmittance of the adjustment layer 203 when a voltage is applied.

As an example, materials constituting the first electrode layer 201 and the second electrode layer 202 can be a metal film layer having a good transmittance. However, in such a case, high requirements are required for the preparation process of film layer, which is easy to cause an increase in the production cost of product.

In order to solve the above problem, the first electrode layer 201 and the second electrode layer 202 can be both made of a transparent conductive material, such as Indium Tin Oxide (ITO), Indium Zinc Oxide (IZO), or Indium Gallium Zinc Oxide (IGZO), etc. These materials are capable of having good electrical conductivity on one hand and involving high light transmittance at the other hand. Thus, when a user uses the above photographic unit 10, influences of the light control structure 20 on the photographic unit 10 can be reduced.

In this case, the electrode layer on a side of the light control structure 20 close to the photographic unit 10, that is, the first electrode layer 201, can be formed directly on the light entrance side A of the photographic unit 10.

Alternatively, as shown in FIG. 4, the light control structure 20 further includes a transparent substrate 204 disposed on a side of the first electrode layer 201 and/or the second electrode layer 202 facing away from the adjustment layer 203.

As an alternative example, two transparent substrate 204 are disposed on a side of the first electrode layer 201 facing away from the adjustment layer 203 and a side of the second electrode layer 202 facing away from the adjustment layer 203 respectively. In this case, the first electrode layer 201 and the second electrode layer 202 are formed on the two transparent substrates 204 by a vapor deposition process respectively. After that, two transparent substrates 204 provided with electrode layers are disposed on both sides of the adjustment layer 203 respectively. In this way, the first electrode layer 201 and the second electrode layer 202 can be supported and protected by the transparent substrates 204.

In view of above, when the first electrode layer 201 and the second electrode layer 202 can be separately formed on the two transparent substrates 204, the sum of thicknesses of the first electrode layer 201 and the transparent substrate 204 is 12.5 μm to 50 μm. Further, the sum of thicknesses of the second electrode layer 202 and the transparent substrate 204 is 12.5 μm to 50 μm. When the sum of thicknesses of any one of the first electrode layer 201 and the second electrode layer 202 and the transparent substrate 204 is less than 12.5 μm, high requirements are required for the preparation process of the electrode layers and the transparent substrate 204, thereby causing an increase in the production cost. In addition, when the sum of thicknesses of any one of the first electrode layer 201 and the second electrode layer 202 and the transparent substrate 204 is greater than 50 μm, the overall thickness of the light control structure 20 is too large, which is disadvantageous for the design trend of ultrathin products. Typically, the thickness of any one of the first electrode layer 201 and the second electrode layer 202 is usually about several hundred nanometers.

Further, the above transparent substrate 204 can be a glass substrate or a transparent resin substrate (for example, a PET substrate). Specifically, the transparent resin substrate can be a thin flexible substrate, such that the PET substrate on which the first electrode layer 201 and the second electrode layer 202 are vapor-deposited thereon can constitute a flexible conductive PET film.

As described above, the electric field formed by the first electrode layer 201 and the second electrode layer 202 in an energized state can control the light transmittance of the adjustment layer 203. Therefore, when the user needs to take a picture using the photographic unit 10, the magnitude of electric field can be controlled, so that the light transmittance of the adjustment layer 203 is improved, thereby reducing influences on the image sharpness of the photographic unit 10. Further, when the user does not need to use the photographic unit 10, by controlling the magnitude of electric field, the light transmittance of the adjustment layer 203 can be lowered. That is, the haze can be increased. In this way, even if the camera lens 101 in the photographic unit 10 is illegally intruded and controlled, the captured image is blurred or even completely invisible, because the adjustment layer 203 can interfere with the sharpness of the camera lens 101. In this way, the purpose of protecting user's privacy or information is achieved.

In summary, on one hand, the adjustment layer 203 in the present application is independent of the structure of photographic unit 10. Thus, the arrangement of adjustment layer 203 does not affect the internal structure of the photographic unit 10. On the other hand, control operations of the adjustment layer 203 and the photographic unit 10 are performed independently without interference between each other. In addition, in the photographic camera 01 provided by the present application, the photographic unit 10 can be physically protected by the adjustment layer 203, so that reliance on software protection is not necessary. In this way, it is not necessary to install software with information protection function, thereby saving storage space of the electronic device and avoiding cumbersome operations caused by keeping updating the software version.

The structure of adjustment layer 203 will be described in detail as follows.

For example, the adjustment layer 203 is a polymer dispersed liquid crystal (PDLC) layer.

Specifically, as shown in FIG. 2, the PDLC layer is composed of liquid crystal molecules 2031 and a polymer 2032, wherein liquid crystal molecules 2031 are dispersed in the polymer, and a large portion of the PDLC layer is occupied by the polymer 2032. In this case, the flexible conductive PET film composed of the first electrode layer 201 and the transparent substrate 204, and the flexible conductive PET film composed of the second electrode layer 202 and the transparent substrate 204, are adhered to both sides of the PDLC layer respectively by the polymer 2032 in the PDLC layer due to its own adhesive force, thus forming the adjustment layer 203.

The process of adjusting the light transmittance of the adjustment layer 203 will be described in the following.

Specifically, when it is not needed to perform photographing using the photographic unit 10, the first electrode layer 201 and the second electrode layer 202 can be brought into a non-energized state. That is, no voltage is applied to the first electrode layer 201 and the second electrode layer 202, so that the electric field between the first electrode layer 201 and the second electrode layer 202 is zero. In this case, as shown in FIG. 2, the liquid crystal molecules 2031 in the PDLC layer are disorderly distributed. Thus, the optical axis of the liquid crystal molecules 2031 is randomly oriented and appears disordered.

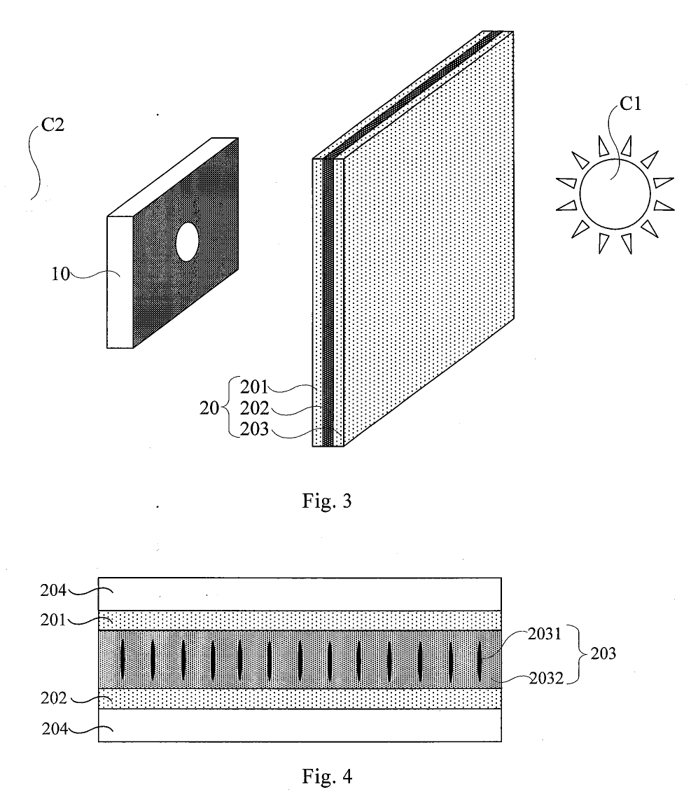

In view of above, the light incident on the adjustment layer 203 is strongly scattered, so that the PDLC layer is opaque or translucent. In this case, the light transmittance of the adjustment layer 203 is relatively low. For example, the transmittance for white light is ≤65%. Correspondingly, the haze is large and can be ≥70%. In this way, it is equivalent to providing a haze film at the light entrance side A of the photographic unit 10, so that only a small part of light incident on the photographic camera 01 from outside can pass through the adjustment layer 203, and is finally incident on the light entrance side A of the photographic unit 10. Thereby, as shown in FIG. 3, the image C2 of a subject C1 on the photographic unit 10 is blurred. In this case, even if the camera lens 101 of the photographic unit 10 is maliciously intruded without the user's knowledge, criminals cannot collect a clear image using the camera lens 101, thereby protecting the user's personal information or privacy effectively.

Further, when the user needs to perform photographing using the photographic unit 10, a voltage can be applied to the first electrode layer 201 and the second electrode layer 202, such that the first electrode layer 201 and the second electrode layer 202 are in an energized state. Specifically, the electric field between the first electrode layer 201 and the second electrode layer 202 can be increased. In this case, as shown in FIG. 4, the liquid crystal molecules 2031 in the PDLC layer are distributed neatly, and the optical axis of the liquid crystal molecules 2031 is perpendicular to the light entrance side of the PDLC layer, that is, being coincident with the direction of electric field. Thereby, the medium inside the PDLC layer is made uniform, and the PDLC layer is transparent.

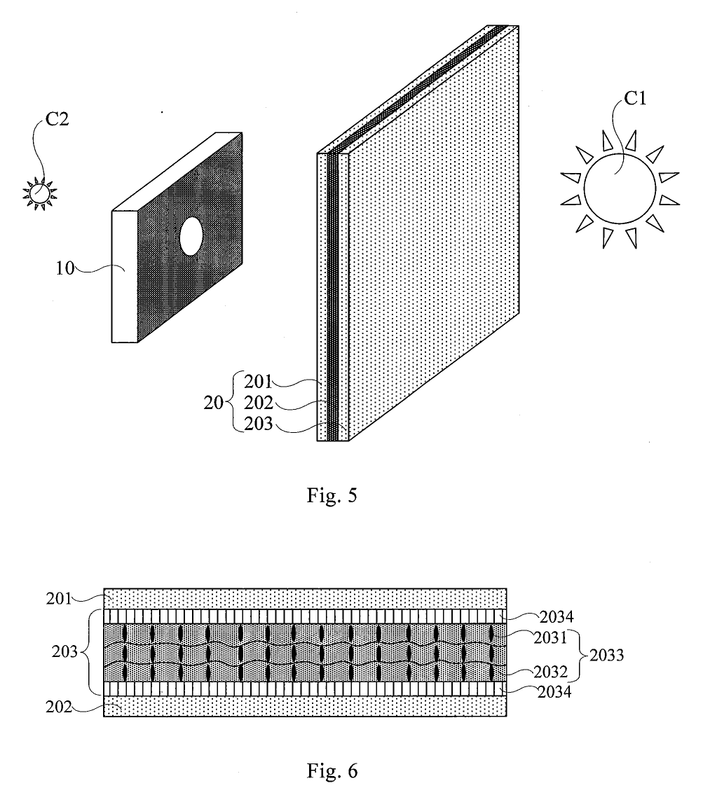

In view of above, the adjustment layer 203 can obtain a high light transmittance. For example, the transmittance for white light is ≤90%. Correspondingly, the haze is small and can be ≥3%. In this way, most of light incident on the photographic camera 01 from outside can pass through the adjustment layer 203, and finally enter the light entrance side A of the photographic unit 10. Thereby, as shown in FIG. 5, the image C2 of a subject C1 on the photographic unit 10 is clear. In this case, when the user performs photographing using the photographic unit 10, the adjustment layer 203 is equivalent to a film layer having a uniform medium and a transmittance close to 100%, thus incurring no influence on the normal photographing of photographic unit 10. In such a case, it is ensured that the user performs a normal photographing operation.

It can be seen from above that in a case where the adjustment layer 203 is a PDLC layer, the adjustment layer 203 does not generate additional power consumption in a protective state, because there is no need to apply a voltage to the electrode layers in the adjustment layer 203 (or alternatively, a zero voltage is applied), if the adjustment layer 203 involves a protection function. Further, when the user performs normal photographing using the photographic unit 10, the power consumption of the adjustment layer 203 can be 5 mW, thus being relatively low.

In view of above, the thickness of the adjustment layer 203 can be 10 μm to 20 μm. When the thickness of the adjustment layer 203 is less than 10 μm, requirements for the manufacturing process are rigid, which is disadvantageous for reducing the production cost. In addition, when the thickness of the adjustment layer 203 is larger than 20 μm, the thickness of the entire light control structure 20 is increased, which is disadvantageous for the design trend of ultrathin products.

In view of above, when the thickness of each of the first electrode layer 201 and the second electrode layer 202 and the thickness of the transparent substrate 204 sum up to 12.5 μm, and the thickness of the adjustment layer 203 is 10 μm, the thickness of the light control structure 20 will be 50 μm. Alternatively, when the thickness of each of the first electrode layer 201 and the second electrode layer 202 and the thickness of the transparent substrate 204 is 50 μm, and the thickness of the adjustment layer 203 is 20 μm, the thickness of the light control structure 20 will be 120 μm. Therefore, the thickness of the adjustment layer 203 ranges from 50 μm to 120 μm. In this way, the thickness of the adjustment layer 203 can be made as small as possible without increasing the manufacturing difficulty and cost.

Alternatively, as shown in FIG. 6, the structure of the adjustment layer 203 can, for example, include a polymer stabilized liquid crystal (PSLC) layer 2033, and alignment layers 2034 on both sides of the PSLC layer 2033.

Specifically, the PSLC layer 2033 is composed of liquid crystal molecules 2031 and a polymer 2032, wherein the liquid crystal molecules 2031 and the polymer 2032 are alternately stacked, and a large portion of the PSLC layer 2033 is occupied by the liquid crystal molecules 2031. The alignment layers 2034 enable the liquid crystal molecules 2031 in the PSLC layer 2033 to be aligned in an initial state (i.e., without any electric field).

In this case, when no voltage is applied to the first electrode layer 201 and the second electrode layer 202 (in other words, a zero voltage is applied), the electric field between the first electrode layer 201 and the second electrode layer 202 will be zero. In this case, the liquid crystal molecules 2031 are in an initial state, and thus distributed neatly. Also, the optical axis of the liquid crystal molecules 2031 is perpendicular to the light entrance side of the PSLC layer 2033, that is, being coincident with the direction of the electric field. In this way, the medium inside the PSLC layer 2033 is uniform, and the PSLC layer 2033 is transparent. In this case, the light transmittance of the adjustment layer 203 composed of the PSLC layer 2033 and the alignment layers 2034 is relatively high. For example, the transmittance for white light is ≤90%. In this way, as shown in FIG. 5, the image C2 of a subject C1 on the photographic unit 10 is clear. In this case, the user can use the photographic unit 10 normally to perform photographing. Moreover, the adjustment layer 203 is equivalent to a film layer having a uniform medium and a transmittance close to 100%, thus incurring no influence on the normal photographing of the photographic unit 10.

Alternatively, when a voltage is applied to the first electrode layer 201 and the second electrode layer 202, specifically, the electric field between the first electrode layer 201 and the second electrode layer 202 is increased. In this case, the liquid crystal molecules 2031 are no longer maintained in the initial state, and the arrangement thereof is disordered. Thereby, the light transmittance of the light control layer 203 is greatly reduced. For example, the light transmittance for white light is 65%. In this way, as shown in FIG. 3, the image C2 of a subject C1 on the photographic unit 10 is blurred. In such a case, when the user no longer uses the photographic unit 10 to perform photographing, even if the camera lens 101 of the photographic unit 10 is maliciously intruded without the user's knowledge, criminals cannot collect a clear image using the camera lens 101, thereby protecting the user's personal information or privacy effectively.

Alternatively, for example, the structure of the adjustment layer 203 can be an electrochromic layer. Specifically, the electrochromic layer is composed of an electrochromic material. In this case, under the electric field formed by the first electrode layer 201 and the second electrode layer 202, the color and transparency of the electrochromic layer can be reversibly changed, thereby adjusting the light transmittance of the adjustment layer 203.

Specifically, for example, when the user needs to perform photographing using the photographic unit 10, the voltage applied to the first electrode layer 201 and the second electrode layer 202 can be adjusted, such that the magnitude of electric field between the first electrode layer 201 and the second electrode layers 202 can be altered. Eventually, the color of the electrochromic layer is made shallow, and the light transmittance of the adjustment layer 203 is greatly improved. In this case, as shown in FIG. 5, the image C2 of a subject C1 on the photographic unit 10 is clear, so that the adjustment layer 203 does not affect the normal photographing of the photographic unit 10.

Alternatively, when the user no longer uses the photographic unit 10 to perform photographing, the magnitude of electric field between the first electrode layer 201 and the second electrode layer 202 can also be adjusted. Eventually, the color of the electrochromic layer is made deeper, and the light transmittance of the adjustment layer 203 is lowered greatly. In this way, as shown in FIG. 3, the image C2 of a subject C1 on the photographic unit 10 is blurred. After that, even if the camera lens 101 of the photographic unit 10 is maliciously intruded without the user's knowledge, criminals cannot collect a clear image using the camera lens 101, thereby protecting the user's personal information or privacy effectively.

In the present application, materials constituting the electrochromic layer can be an organic material or an inorganic material. When an inorganic material is used, optionally, materials constituting the electrochromic layer include a nickel oxide electrochromic material. By adjusting the magnitude of electric field between the first electrode layer 201 and the second electrode layer 202, the nickel oxide electrochromic material can be changed from transparent to dark brown. Therefore, when the nickel oxide electrochromic material is transparent, the light transmittance of the adjustment layer 203 can be made large. For example, the transmittance for white light is 90%, and correspondingly, the haze is ≤3%. Similarly, when the nickel oxide electrochromic material is dark brown, the light transmittance of the adjustment layer 203 can be made small. For example, the transmittance for white light is ≤65%, and correspondingly, the haze is ≥70%.

The present disclosure also provides a display device. The display device includes the photographic camera 01 as described in any of the above embodiments. The display device has the same advantageous effects as the photographic camera 01 provided in the above embodiment, and will not be described herein.

It should be noted that, in an embodiment of the present disclosure, the display device can include at least a liquid crystal display device and an organic light emitting diode display device. For example, the display device can be any product or component having a display function, such as a liquid crystal display, a liquid crystal television, a digital photo frame, a mobile phone, or a tablet computer.

The above embodiments are only used for explanations rather than limitations to the present disclosure. The ordinary skilled person in the related technical fields may also make various modifications and variations without departing from the spirit and scope of the present disclosure, and all these equivalent solutions shall belong to the scope of the present disclosure. Therefore, the patent protection scope of the present disclosure should be defined by the appended claims.

### LIST OF REFERENCE NUMERALS

01—photographic camera
10—photographic unit
101—camera lens
20—light control structure
201—first electrode layer
202—second electrode layer
203—adjustment layer
2031—liquid crystal molecule
2032—polymer
2033—PSLC layer
2034—alignment layer
204—transparent substrate
A—light entrance side of photographic unit
C1—subject
C2—image of subject on photographic unit

1. A photographic camera, comprising:
a photographic unit; and
a light control structure disposed at a light entrance side of the photographic unit,
wherein the light control structure comprises a first electrode layer and a second electrode layer disposed opposite to each other and an adjustment layer disposed between the first electrode layer and the second electrode layer,
wherein the first electrode layer and the second electrode layer are configured to form an electric field for controlling light transmittance of the adjustment layer when a voltage is applied thereto.

2. The photographic camera according to claim 1,
wherein the adjustment layer comprises a polymer dispersed liquid crystal layer.

3. The photographic camera according to claim 2,
wherein a thickness of the adjustment layer is about 10 μm to 20 μm.

4. The photographic camera according to claim 1,
wherein the adjustment layer comprises a polymer stabilized liquid crystal layer and alignment layers on both sides of the polymer stabilized liquid crystal layer.

5. The photographic camera according to claim 1,
wherein the adjustment layer comprises an electrochromic layer.

6. The photographic camera according to claim 5,
wherein the electrochromic layer is formed of a nickel oxide electrochromic material.

7. The photographic camera according to claim 1,
wherein the first electrode layer and the second electrode layer are both formed of a transparent conductive material.

8. The photographic camera according to claim 1, further comprising:
a transparent substrate disposed on a side of at least one of the first electrode layer or the second electrode layer facing away from the adjustment layer.

9. The photographic camera according to claim 8,
wherein a thickness of the first electrode layer and a thickness of the transparent substrate sum to about 12.5 μm to 50 μm.

10. The photographic camera according to claim 8,
wherein a thickness of the second electrode layer and a thickness of the transparent substrate sum to about 12.5 μm to 50 μm.

11. A display device, comprising the photographic camera according to claim 1.

12. The display device according to claim 11,
wherein the adjustment layer comprises a polymer dispersed liquid crystal layer.

13. The display device according to claim 12,
wherein a thickness of the adjustment layer is about 10 μm to 20 μm.

14. The display device according to claim 11,
wherein the adjustment layer comprises a polymer stabilized liquid crystal layer and alignment layers on both sides of the polymer stabilized liquid crystal layer.

15. The display device according to claim 11,
wherein the adjustment layer comprises an electrochromic layer.

16. The display device according to claim 15,
wherein the electrochromic layer is formed of a nickel oxide electrochromic material.

17. The display device according to claim 11,
wherein the first electrode layer and the second electrode layer are both formed of a transparent conductive material.

18. The display device according to claim 11, wherein the photographic camera further comprises:
a transparent substrate disposed on a side of at least one of the first electrode layer or the second electrode layer facing away from the adjustment layer.

19. The display device according to claim 18,
wherein a thickness of the first electrode layer and a thickness of the transparent substrate sum to about 12.5 μm to 50 μm.

20. The display device according to claim 18,
wherein a thickness of the second electrode layer and a thickness of the transparent substrate sum to about 12.5 μm to 50 μm.
